(19) United States
(12) Patent Application Publication
(10) Pub. No.: US 2025/0153255 A1
(43) Pub. Date: May 15, 2025

(54) IN-LINE POCKET SHEAR

(71) Applicant: Felix SORKIN, Stafford, TX (US)

(72) Inventor: Felix SORKIN, Stafford, TX (US)

(21) Appl. No.: 18/946,621

(22) Filed: Nov. 13, 2024

Related U.S. Application Data
(60) Provisional application No. 63/598,219, filed on Nov. 13, 2023.

(51) Int. Cl. B23D 17/06

(52) U.S. Cl. CPC B23D 17/06

(57) ABSTRACT

This application details a configuration for an in-line tendon shear, which may also be referred to as an in-line pocket shear. Exemplary embodiments may improve upon existing cutters and shears for tendons in post-tensioning operations by being advantageously more compact, efficient, can cut in multiple planes, such as horizontal and vertical planes, and may include additional other benefits. The in-line tendon shear has components that are aligned with a central axis of a tendon.

### RELATED APPLICATIONS

This application claims priority to U.S. Provisional Application 63/598,219, entitled “In-Line Pocket Shear,” filed on Nov. 13, 2023. The contents of this priority application are incorporated by reference herein in their entirety.

### FIELD OF THE DISCLOSURE

The present disclosure relates to post-tensioning concrete, and more specifically, a method and device for cutting stressing tendons.

### BACKGROUND

Many structures are built using concrete, including, for instance, buildings, parking structures, apartments, condominiums, hotels, mixed-use structures, casinos, hospitals, medical buildings, government buildings, research/academic institutions, industrial buildings, malls, bridges, pavement, tanks, reservoirs, silos, foundations, sports courts, and other structures.

Pre-stressed concrete is structural concrete in which internal stresses are introduced to reduce potential tensile stresses in the concrete resulting from applied loads. Pre-stressing may be accomplished by post-tensioned pre-stressing or pre-tensioned prestressing. In post-tensioned pre-stressing, a tension member is tensioned after the concrete has attained a desired strength by use of a post-tensioning tendon. The post-tensioning tendon may include for example and without limitation, anchor assemblies, the tension member, and sheathes.

Traditionally, a tension member is constructed of a material that can be elongated and may be a single or a multi-strand cable. The tension member may be formed from a metal, such as reinforced steel. The post-tensioning tendon traditionally includes an anchor assembly at each end. The tension member is fixedly coupled to a fixed anchor assembly positioned at one end of the post-tensioning tendon, the “fixed end,” and stressed at the stressed anchor assembly positioned at the opposite end of the post-tensioning tendon, the “stressing end” of the post-tensioning tendon.

In a typical tendon tensioning anchor assembly in post-tensioning operations, there are provided anchors for anchoring the ends of the cables suspended therebetween. In the course of installing the cable tensioning anchor assembly in a concrete structure, a hydraulic jack or the like is releasably attached to one of the exposed ends of cable (the stressing end) for applying a predetermined amount of tension to the tendon. When the desired amount of tension is applied to the cable, wedges, threaded nuts, or the like, are used to capture the cable and, as the jack is removed from the tendon, to prevent its relaxation and hold it in its stressed condition.

After the concrete member is stressed, the tension member extends beyond the edge of the concrete segment. The portion of the tension member that extends beyond the edge of the concrete member is removed by cutting. Methods of cutting include an abrasive saw or an arm with a sharp edge that cuts the cable, and a conventional acetylene torch or cutting torch. However, use of the open flame of a torch creates some danger of fire or explosion in the surrounding environment. Also, cutting the metal cable with a torch at a point near to the tensioning wedges causes the cable and wedges to become heated and may result in a loss of temper of the metal or loosening of the post-tensioning wedges. Further, using torches to cut tendons often requires operators to obtain hot work permits, which can be costly and time consuming.

GTI's hydraulic tendon cutter, as shown in FIG. 1 at 100, is a durable, field tested, and proven design but is oriented at a right angle to the tendon axis. While the tendon cutter shown in FIG. 1, and also in U.S. Pat. No. 12,134,119, is useful, there are deficiencies which exemplary embodiments of the present disclosure address.

### SUMMARY

Exemplary embodiments include an in-line strand cutter including a cylinder for applying linear force; a gear train for translating the linear force to rotational force; a nose piece comprising a blade assembly mechanically coupled to the gear train to receive the rotational force; a clamp assembly mechanically coupled to the drive assembly that also receives the rotational force; wherein the cylinder, nose piece, and clamp assembly are aligned along an axis parallel to a strand.

### BRIEF DESCRIPTION OF THE DRAWINGS

Various embodiments of the present disclosure, together with further objects and advantages, may best be understood by reference to the following description taken in conjunction with the accompanying drawings.

FIG. 1 shows a prior art tendon cutter.

FIG. 2 shows a perspective view of an exemplary in-line pocket shear according to an embodiment of the present disclosure.

FIG. 3 shows a rear perspective view of the exemplary in-line pocket shear according to an embodiment of the present disclosure.

FIG. 4 shows a second rear perspective view of the exemplary in-line pocket shear according to an embodiment of the present disclosure.

FIG. 5A shows a top view of the exemplary in-line pocket shear according to an embodiment of the present disclosure.

FIG. 5B shows a side view of the exemplary in-line pocket shear according to an embodiment of the present disclosure.

FIG. 5C shows a bottom view of the exemplary in-line pocket shear according to an embodiment of the present disclosure.

FIG. 6A shows a top view of the exemplary in-line pocket shear with a Section 6B-6B indicated according to an embodiment of the present disclosure.

FIG. 6B shows the cross-sectional view taken along the line 6B-6B of FIG. 6A.

FIG. 7 shows an exploded view of the exemplary in-line pocket shear to illustrate the gear train according to an embodiment of the present disclosure.

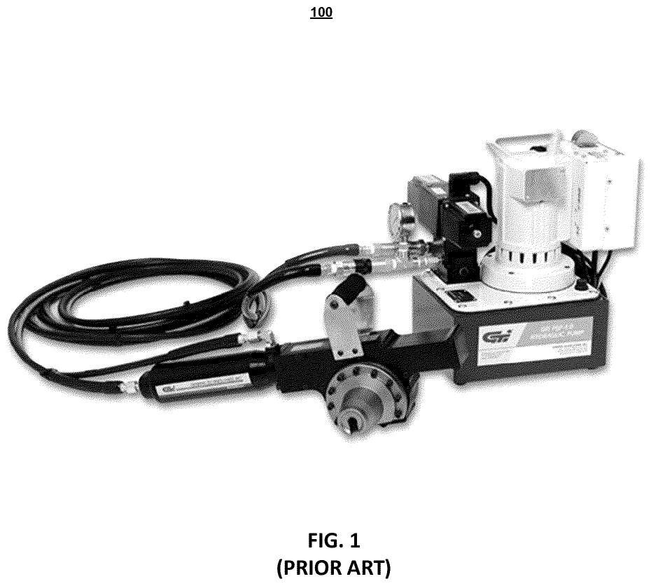

These and other objects, features and advantages of the exemplary embodiments of the present disclosure will become apparent upon reading the following detailed description of the exemplary embodiments of the present disclosure, when taken in conjunction with the appended paragraphs.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

This application details a configuration for an inline tendon shear, which may also be referred to as an in-line pocket shear and may be referred to herein as a shear. Exemplary embodiments may improve upon existing cutters and shears for tendons in post-tensioning operations by being advantageously more compact, efficient, can cut in multiple planes, and may include additional other benefits.

Exemplary embodiments of the present disclosure may be compatible with prestressing configurations including groups of multiple strands, or tendons, in close proximity to each other. In some exemplary embodiments, the device may be capable of cutting both vertically and horizontally. In additional embodiments, the nose of the cutter may include a groove and tongue for precise connection. Exemplary embodiments may be hydraulic or battery powered. Further, the cutter may include a display which shows pump pressure, number of cycles, battery condition and/or other info linked with control system for the line. The strand is cut by receiving the strand in a nose piece assembly having a rotating blade assembly, also receiving and securing the strand in a clamp assembly, and rotating a shear blade relative to a fixed blade to cut the strand.

The shear according to exemplary embodiments may have a housing which contains a drive train and to which is mounted a nose piece, containing a blade assembly and a clamp assembly. A hydraulic cylinder may be mounted to the housing to provide force to operate the shear (i.e., power the blade assembly to cut a strand). A handle may be mounted on the upper part of the housing. The housing may include a trigger or other means to actuate and operate the shear. Gauges and/or other means for displaying operational parameters may be provided.

To cut a strand with the in-line shear of exemplary embodiments, the shear 200, as described below, is placed onto the strand at the desired location along the strand. The strand is align with and received in, and aligned with, the nose piece 208 and clamp assemblies 214.

The shear may then be actuated to cause the operation thereof. Power, in the form of linear motion, is provided by the cylinder. This linear motion is translated to rotary motion, or torque, which is applied to a rotating blade assembly that rotates relative to strand (and the shear 200). A fixed blade is non-rotatably mounted and engaged with the strand. Because the rotating blade rotates relative to fixed blade, the strand is thereby sheared (or cut). When rotating blade assembly has rotated 180° relative to the fixed blade, the strand will be completely cut. The shear can then be removed from the strand and the rotating blade assembly can be returned to the open position and the shear removed from the strand.

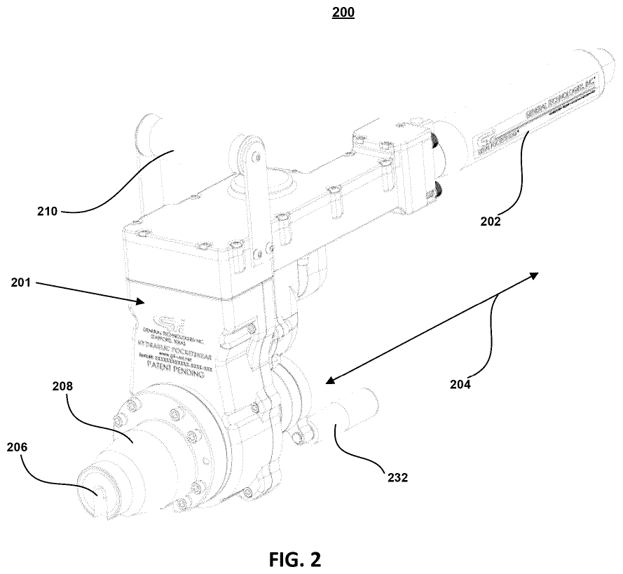

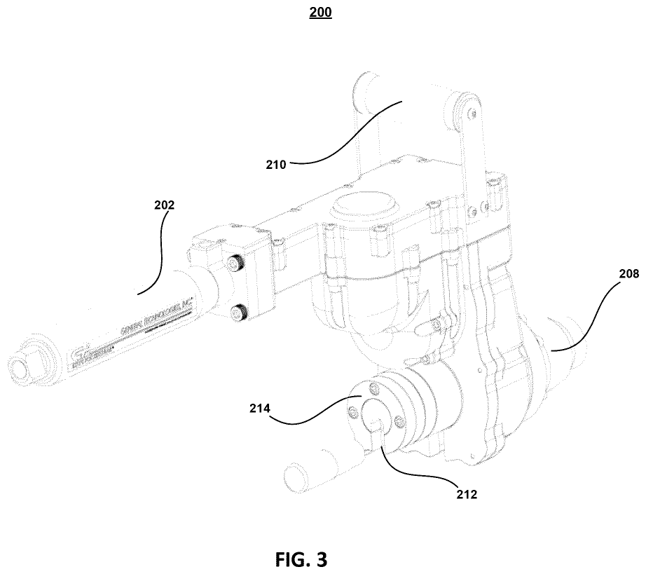

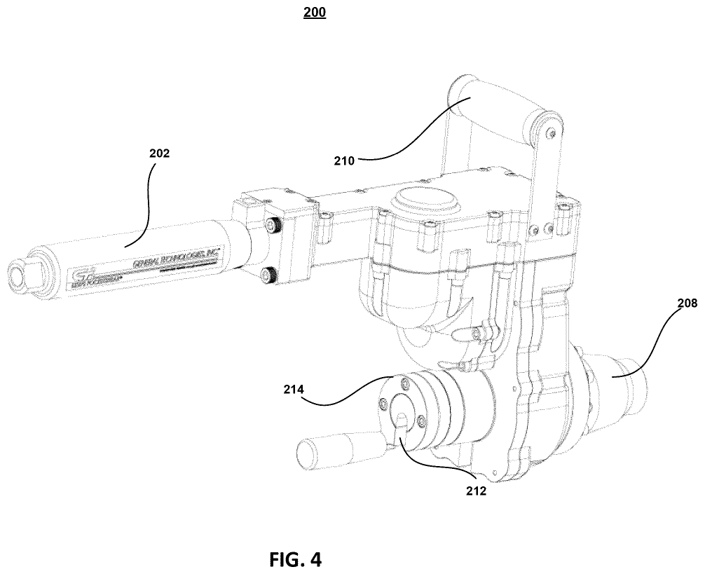

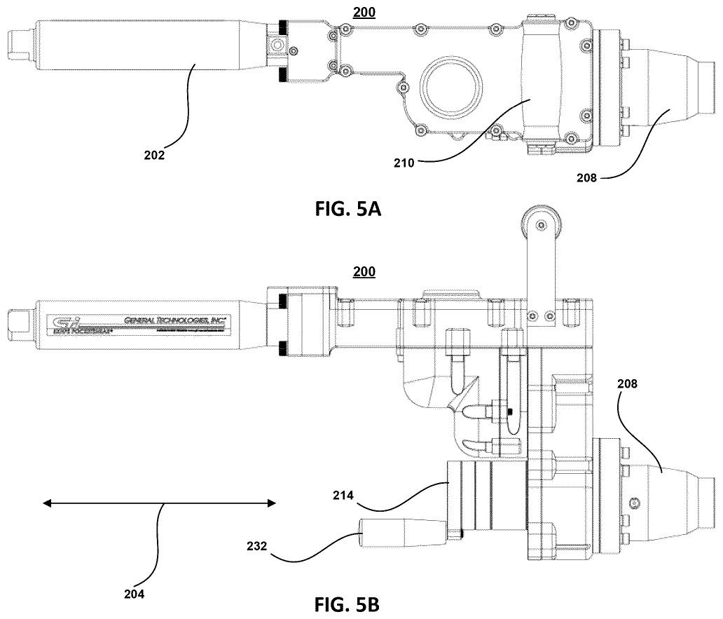

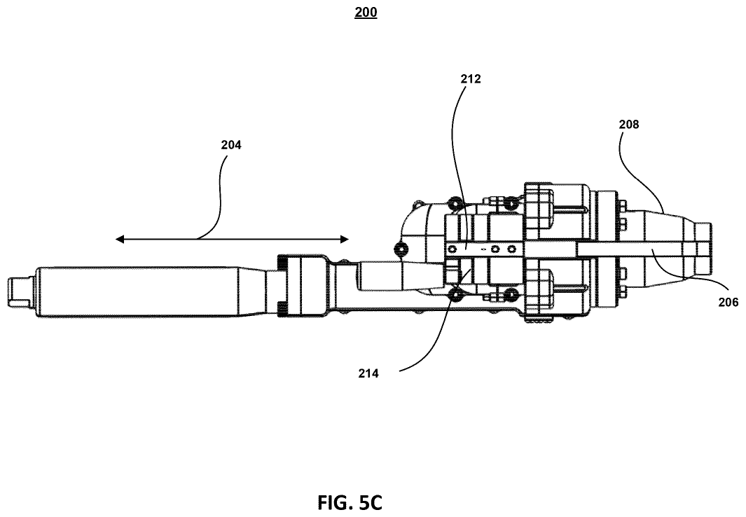

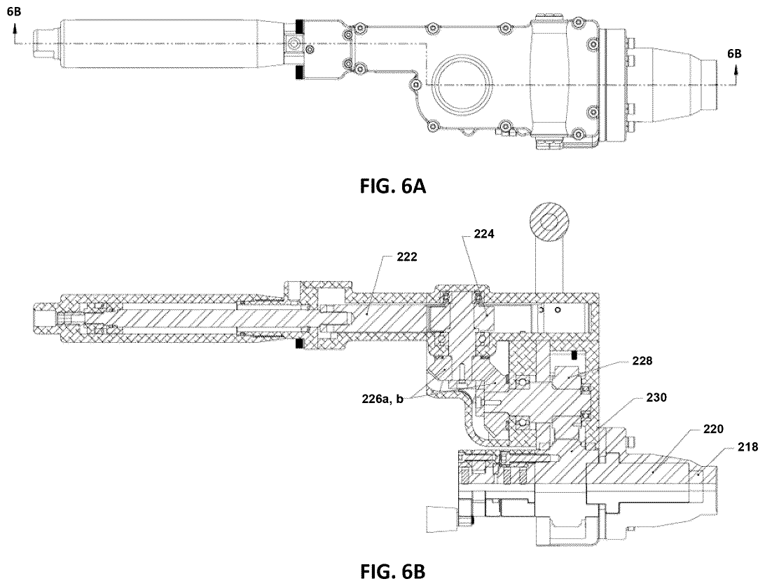

The inline tendon shear 200, as shown in FIGS. 2-7, including FIGS. 5A, 5B, 5C, 6A and 6B, may be more compact than existing designs allowing for it to be used in scenario where conventional tendon shears cannot fit. The shear 200 has a housing 201 to which a high pressure cylinder 202 is mounted. The compact design may be due, in part, to the implementation of a smaller high pressure cylinder 202. In various embodiments the cylinder 202 is hydraulic, as depicted. Power to operate or actuate the cylinder may be provided by an external connection. In some embodiments, the shear may be powered by a battery (not shown) and may be self-contained. In other embodiments, a connection to an external hydraulic circuit (not shown) may be required for operation (i.e., to provide the power source to actuate the cylinder). That is, a hydraulic line with a coupling may be attached to the end of the cylinder. In various embodiments, the power input may be an external electric connection.

The advantages of exemplary embodiments may also be partially due to the device engaging a tendon in the same axis as the tendon, as opposed to cutting at a right angle to the tendon, as is the case with conventional designs. The tendon axis is shown as line 204, which can be seen to align with the throat 206 of the nose piece 208 of the shear 200. The tendon is aligned with the throat to engage with the shear 200. The nosepiece 208 contains a fixed blade assembly 218 and a rotating blade assembly 220, which each contain a shear blade. The fixed and rotating blades may be replaceable. The rotating blade is driven by a gear train to cut the tendon by rotating about the tendon axis, which aligns with a cutting axis of the shear 200. To cut a strand, the rotating blade assembly may rotate 180° about the cutting axis. The blades may be selected from a variety of different blades of different materials or hardnesses, depending on the cutting application.

Opposite the nose piece may be a clamp assembly 214 with has a strand channel 212, which is also aligned with the tendon axis (as is the throat). The clamp assembly serves to secure the tendon during cutting operations. A handle 210 may facilitate manipulation and operation of the shear 200.

In exemplary embodiments, the clamp assembly is mechanically coupled to the gear train. to allow the clamp assembly to rotate about the cutting axis in conjunction with the rotating blade as described above. The clamp assembly may receive the strand in its channel. The clamp assembly may rotate with the rotating blade assembly. In various embodiments, the handle 232 can be used to rotate the clamp assembly to secure the strand. The handle may also be used to open the clamp assembly to manually to release a tendon. In various embodiments, the clamp assembly may be differently structured and have two spring loaded arms. The clamp assembly may receive the tendon in the strand channel though an opening in two clamp arms which are normally urged together by a spring or other tension means. Once received, the clamp arms serve to contain and secure the tendon for the cutting operation.

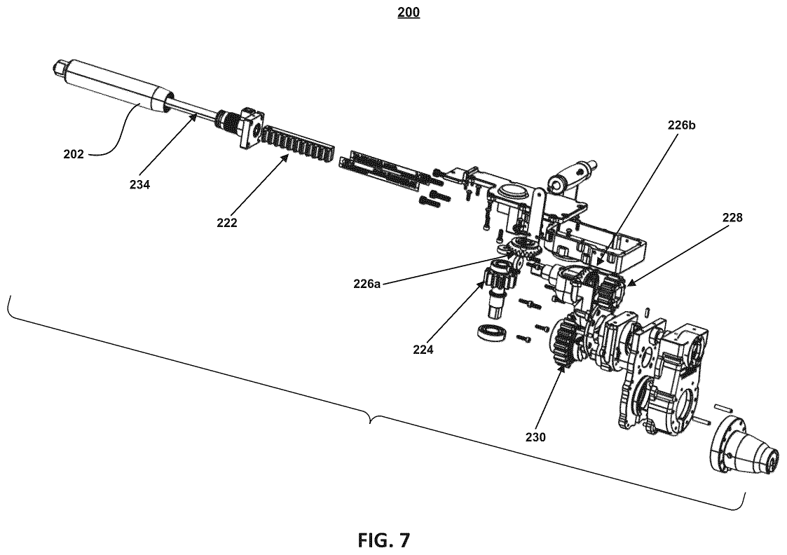

In exemplary embodiments, the linear force of the cylinder is translated to rotary motion by a drive train that comprises a gear train. FIG. 6B provides a cross-sectional view and FIG. 7 provides an exploded view of the shear 200 to illustrate the gear train. The gear train may consist of gear rack 222, spur gear 224, miter gears 226, and spur gear 228 and 230.

The gear rack 222 is attached to the cylinder piston rod 234 such that actuation of the cylinder, causes the gear rack to move linearly. The gear rack 222 mates with spur gear 224 such that movement of the gear rack cause spur gear 224 to rotate. Thus, the linear motion of the cylinder is translated to rotational motion. The spur gear 224 is mated with miter gears 226a, b. The two miter gears mounted at right angles to one another (the miter gear 226a is mounted in the horizontal plane and is mated with the spur gear 224 and translates the rotational input by 90° to miter gear 226b which is mounted in the vertical plane). The miter gear 226b is coupled directly to spur gear 228. Spur gear 228 is mated with spur gear 230. Spur gear 230 is coupled to output shaft that is coupled to the rotating blade assembly and also to the clamp assembly. Thus, the linear input of the cylinder is translated to a rotational output using the gear train of exemplary embodiments.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

Further, it is to be understood that the terminology used herein is for the purpose of describing particular embodiments only and is not intended to be limiting. The terms “a” or “an” as used herein, are defined as one or more than one.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

1. An in-line strand cutter, comprising:
a cylinder for applying a linear force, wherein the cylinder is hydraulic;
a gear train for translating the linear force to rotational force;
a nose piece comprising a blade assembly, wherein at least a portion of the blade assembly is mechanically coupled to the gear train to receive the rotational force; and
a clamp assembly that is mechanically coupled to the gear train such that the clamp assembly receives the rotational force;
wherein the cylinder, nose piece, and clamp assembly are configured to be aligned along an axis parallel to a strand to be sheared by the blade assembly.

2. The in-line strand cutter of claim 1, the blade assembly comprising a rotational shear blade assembly and a fixed blade, wherein the rotational shear blade is mechanically coupled to the gear train and the rotational shear blade is configured to rotate relative to the fixed blade when the rotational shear blade is driven by the gear train.

3. The in-line strand cutter of claim 1, the nose piece further comprising a throat configured to fit over the strand and the clamp assembly further comprising a strand channel configured to fit over the strand.

4. The in-line strand cutter of claim 1, the nose piece located at one end of the in-line strand cutter and the clamp assembly located opposite the nose piece on a second end of the in-line strand cutter.

5. The in-line strand cutter of claim 1, wherein the in-line strand cutter is portable.

6. (canceled)

7. The in-line strand cutter of claim 1, wherein the strand is horizontal and the cylinder, nose piece, and clamp assembly are aligned along an axis parallel to the strand.

8. The in-line strand cutter of claim 1, wherein the strand is vertical and the cylinder, nose piece, and clamp assembly are aligned along an axis parallel to the strand.

9. The in-line strand cutter of claim 1, the gear train comprising:
a gear rack mechanically coupled to a piston rod of the cylinder;
the gear rack being mated with a first spur gear;
the first spur gear being mated with a first miter gear that is oriented in a matching orientation to the first spur gear;
the first miter gear being mated with a second miter gear oriented at ninety degrees to the first miter gear;
the second miter gear being mechanically coupled to a second spur gear in a same orientation as the second miter gear; and
the second spur gear being mated with a third spur gear that is mechanically coupled to at least a portion of the blade assembly and the clamp assembly.
